(19) United States
(12) Patent Application Publication
(10) Pub. No.: US 2011/0259820 A1
(43) Pub. Date: Oct. 27, 2011

(54) BUOYANT PLANT HABITAT

(75) Inventors: Kevin Shea Songer, Jacksonville, FL (US); Rinaldo Joseph DiLoreto, III, St. Augustine, FL (US)

(73) Assignee: ACF Environmental, Inc., Richmond, VA (US)

(21) Appl. No.: 12/765,170

(22) Filed: Apr. 22, 2010

(51) Int. Cl. C02F 3/32; A01G 31/02

(52) U.S. Cl. 210/602; 47/63

(57) ABSTRACT

Embodiments of the invention provide a buoyant plant habitat for removing excess nutrients and other pollutants from a body of water and thereby remediating the water. The buoyant plant habitat may be used to remediate any suitable body of water, including ponds and lakes (both natural and manmade), streams and rivers, and stormwater, wastewater or drainage ponds. The buoyant plant habitat comprises a rigid, non-biodegradable grid structure into which a plurality of aquatic plants is placed. As the plants grow, they take up excess nutrients (nitrogen and phosphorous) and other pollutants from the water. From time to time, the top portions of the plants are removed by cutting. This cutting of the permanently removes the excess nutrients that have been taken up and stored by the cut portion of the plants. The cut plant matter may then be composted or otherwise disposed of.

### FIELD OF THE INVENTION

The present invention generally relates to systems and methods of removing excess nutrients and other contaminants from bodies of water.

### BACKGROUND OF THE INVENTION

Nutrients occur naturally in our soils and waters. They act as a fertilizer and are a necessity for plant growth. However like most things, these nutrients (especially nitrogen and phosphorous) are harmful if they are present in excess amounts. Lawn and plant fertilizer and animal waste (including human sewage) contain nitrogen, phosphorus, metals, bacteria and other pollutants. Water which runs off the land into creeks, rivers, ponds (including manmade retention ponds), and lakes can carry these nutrients and pollutants, thereby leading to an excessive amount of nutrients and pollutants in these bodies of water.

Excessive nutrients and pollutants in a body of water mean too much plant growth, especially of algae. When there is too much algae, the water becomes cloudy and blocks light to submerged aquatic vegetation (SAV), which kills the SAV. SAV is an important food source to many aquatic animals. Other problems occur when the algae die and decompose, in that they use up much of the oxygen in the water. This reduced oxygen level can adversely affect aquatic animals.

### BRIEF SUMMARY OF THE INVENTION

In one embodiment of the invention, a buoyant plant habitat comprises a rigid grid structure, a floatation element, and a plurality of aquatic plants. The rigid grid structure comprises a plurality of cells in a single layer horizontally planar arrangement, each cell having a top, a bottom, and at least three sides, each cell having openings defined in its top, bottom, and at least two of the at least three sides. The flotation element is coupled to the grid structure. At least one of each aquatic plant is inserted within one of the cells.

The plurality of cells may each comprise a cubic cell having a top, a bottom, and four sides. The plurality of cells may be arranged in a single layer.

The buoyant plant habitat may further comprise two or more rigid grid structures joined by one or more flexible connector elements. The rigid grid structure may comprise a non-biodegradable material, such as a polymer.

The flotation element may comprise one or more closed pipes inserted through the openings of and thereby spanning a plurality of cells. The flotation element may further comprise buoyant material within one or more of the closed pipes.

The buoyant plant habitat may further comprise a sub-structure affixed to and positioned below at least a portion of the grid structure such that a gap is maintained between a bottom of the grid structure and the non-permeable sub-structure. The sub-structure may comprise a geotextile. Opposing ends of the geotextile may be affixed to respective opposing ends of the grid structure such that the geotextile hangs down from the grid structure.

In addition to the buoyant plant habitat, as described above, other aspects of the present invention are directed to corresponding methods of remediating contaminated water.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a buoyant plant habitat in place in a body of water, in accordance with embodiments of the present invention;

FIG. 2 is a top perspective view of a buoyant plant habitat, in accordance with embodiments of the present invention;

FIG. 3 is a bottom perspective view of a buoyant plant habitat, in accordance with embodiments of the present invention;

FIG. 4 is a perspective view of a rigid grid structure of a buoyant plant habitat, in accordance with embodiments of the present invention;

FIG. 5 is an enlarged view of four cells of the rigid grid structure of FIG. 4;

FIG. 6 illustrates partial top views of four possible cell shape configurations a rigid grid structure of a buoyant plant habitat, in accordance with embodiments of the present invention;

FIG. 7 is a cross-sectional view of a buoyant plant habitat, in accordance with embodiments of the present invention;

FIG. 8 is a top view of a multi-grid buoyant plant habitat, in accordance with embodiments of the present invention;

FIG. 9 is a perspective cut-away view of a flotation element of a buoyant plant habitat, in accordance with embodiments of the present invention; and

FIG. 10 is a perspective view of a buoyant plant habitat, in accordance with an alternative embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention comprise a buoyant plant habitat for removing excess nutrients and other pollutants from a body of water and thereby remediating the water. The buoyant plant habitat of embodiments of the invention may be used to remediate any suitable body of water, including ponds and lakes (both natural and manmade), streams and rivers, and stormwater, wastewater, water treatment or drainage ponds. The buoyant plant habitat of embodiments of the invention comprises a rigid, non-biodegradable grid structure (discussed in more detail below) into which a plurality of aquatic plants is placed. As the plants grow, they remove excess nutrients (nitrogen and phosphorous) and other pollutants from the water.

From time to time (e.g., quarterly), the top portions of the plants may be removed (such as by cutting) from the buoyant plant habitat. This cutting of the plants to facilitate removal of some of the plant matter permanently removes the excess nutrients and contaminants that have been taken up and stored by the cut portion of the plants. The cut plant matter may then be composted or otherwise disposed of. After cutting, the same plants remain on the buoyant plant habitat and in the water to allow further growth of the same plants and further removal of excess nutrients by the same plants. This method of cutting the plants to remove the excess nutrients is a significant improvement over known methods that require complete removal and replacement of the plants. The cutting of the top portions of the plants may be performed while the buoyant plant habitat is in the water, or the buoyant plant habitat may be temporarily removed from the water to facilitate the cutting.

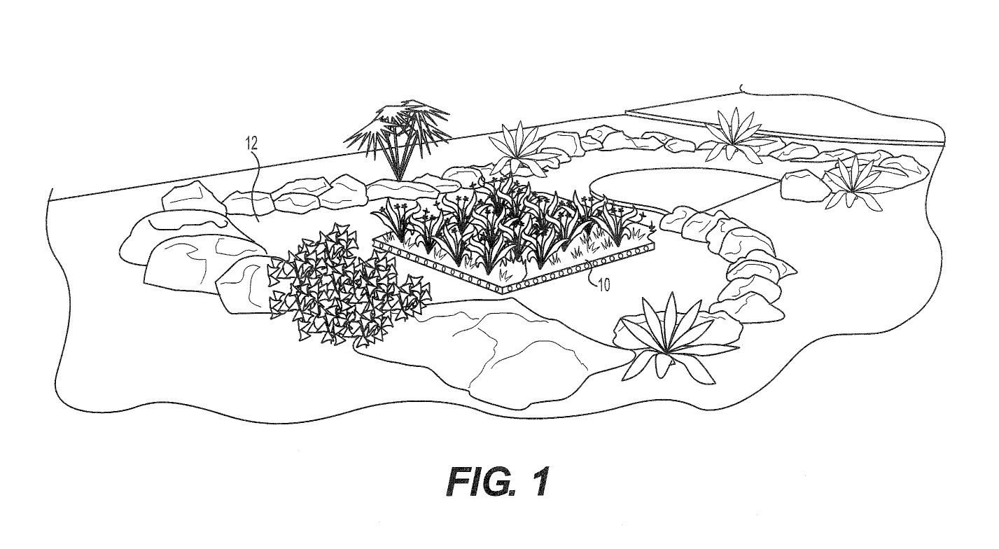

Referring now to FIG. 1, a perspective view of a buoyant plant habitat in place in a body of water is illustrated in accordance with embodiments of the present invention. The buoyant plant habitat 10 is illustrated floating in a pond 12. As discussed above, the pond 12 may in fact be any suitable body of water from which it is desirable to remove excess nutrients or other pollutants. The buoyant plant habitat may be tethered or anchored (not illustrated) to the bottom of the pond to limit movement of the buoyant plant habitat.

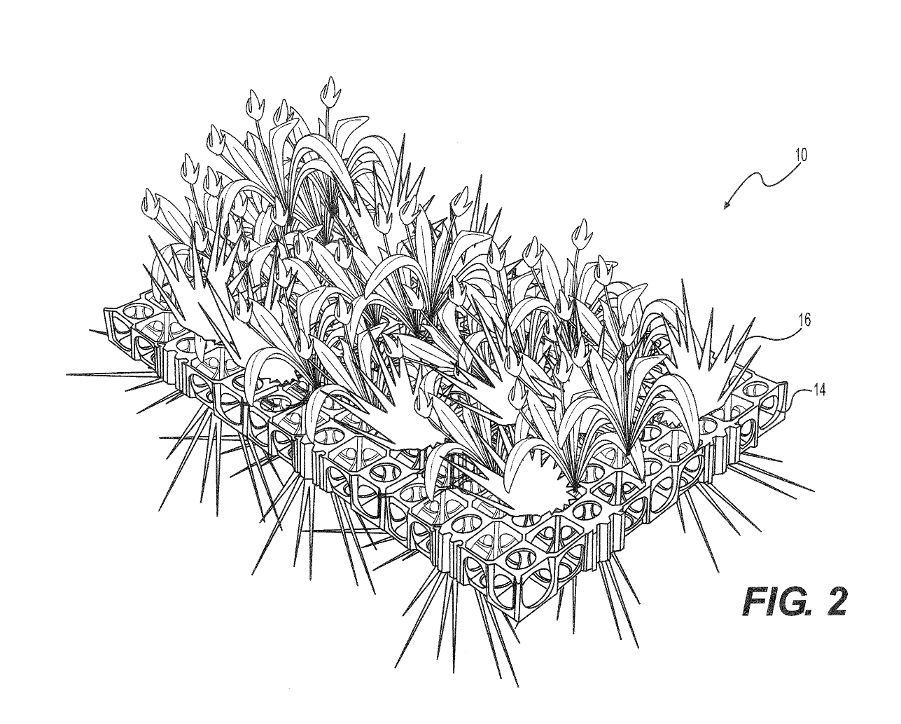

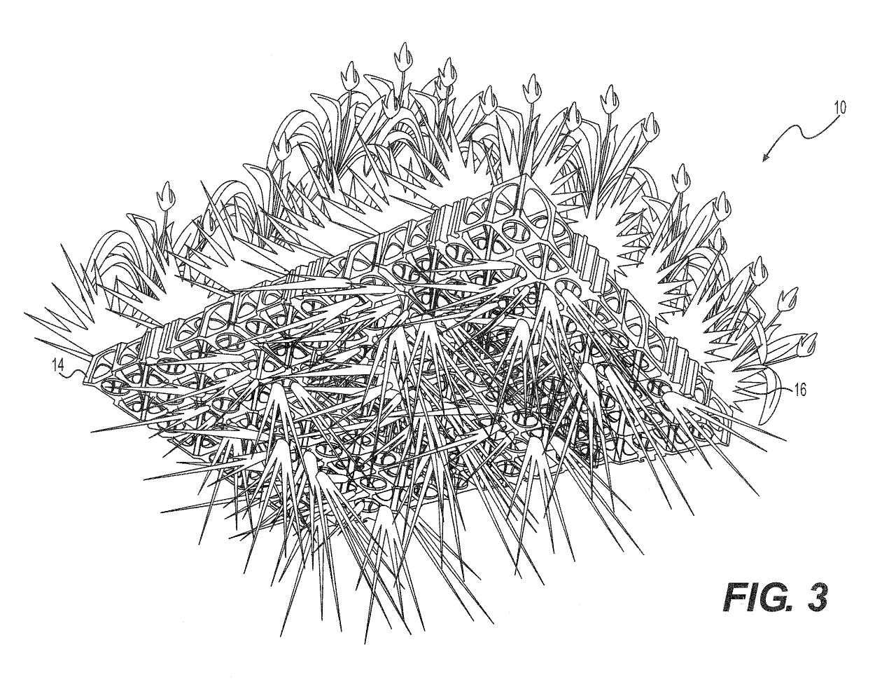

Referring now to FIGS. 2 and 3, respective top and bottom perspective views of a buoyant plant habitat are illustrated in accordance with embodiments of the invention. As seen in FIGS. 2 and 3, the buoyant plant habitat 10 comprises a buoyant rigid grid structure 14 (discussed in more detail below) supporting a plurality of aquatic plants 16. The specific plants used may be selected based on nutrient removal guideline charts and consultations with a wetland biologist knowledgeable with area in which the buoyant plant habitat is to be located. Typically, plants that are native to the area are selected. Also, it is typically desirable to have a large percentage (e.g., at least about 80%) of the plants be evergreen, and the plants should typically have a low leaf litter rate.

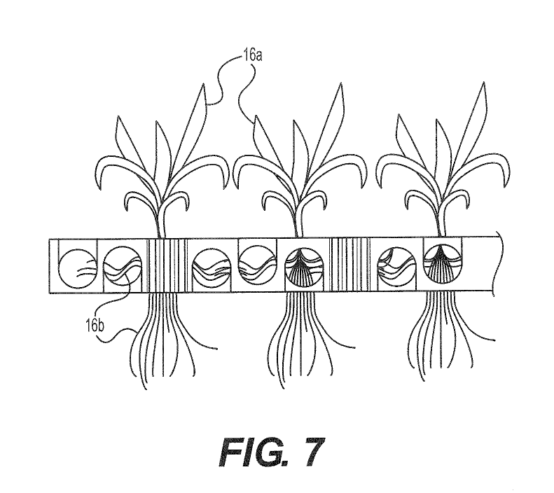

As seen in FIGS. 2 and 3, the plants comprise top portions (i.e., stems, leaves, etc.) above the grid structure and bottom portions (i.e., roots) below the grid structure thereby submerged. As seen in FIG. 7, the roots of the plants also grow within and between the void spaces of the grid structure (discussed below).

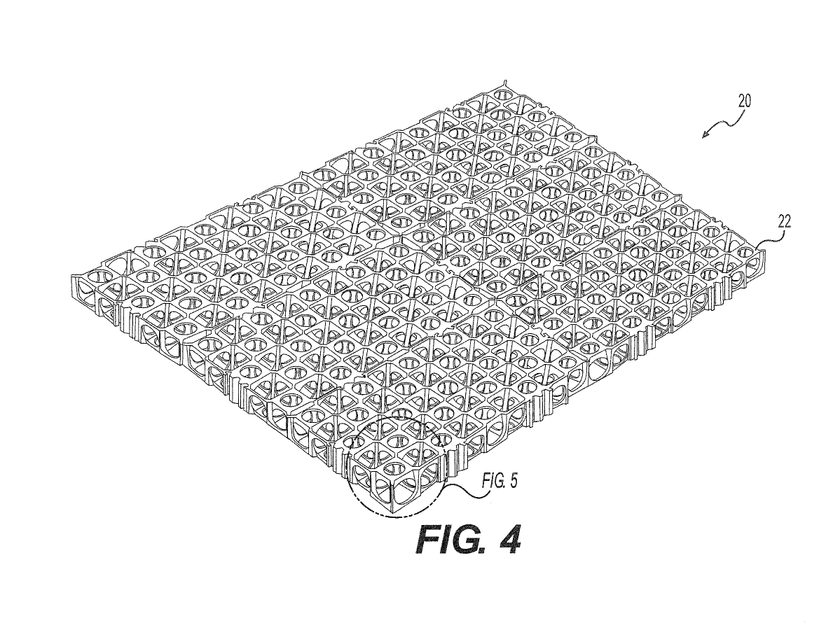

Referring now to FIG. 4, a perspective view of a rigid grid structure of a buoyant plant habitat is illustrated in accordance with embodiments of the present invention. The grid structure 20 of FIG. 4 provides the main structure of the buoyant plant habitat of embodiments of the invention. The grid structure 20 is preferably rigid and comprises a non-biodegradable material. The grid structure may comprise any suitable rigid, non-biodegradable material, including but not limited to polymers (e.g., acrylonitrile butadiene styrene (ABS), polyacrylonitrile (PAN) or Acrylic, polybutadiene, poly(butylene terephthalate) (PBT), poly(ether sulfone) (PES, PES/PEES), poly(ether ether ketone)s (PEEK, PES/PEEK), polyethylene (PE), poly(ethylene glycol) (PEG), poly(ethylene terephthalate) (PET), polypropylene (PP), polytetrafluoroethylene (PTFE), styrene-acrylonitrile resin (SAN), poly(trimethylene terephthalate) (PTT), polyurethane (PU), polyvinyl butyral (PVB), polyvinylchloride (PVC), polyvinylidenedifluoride (PVDF), poly(vinyl pyrrolidone) (PVP), or nylon), metals (e.g., aluminum), or composites. The grid structure of embodiments of the invention may also comprise a material that is resistant to ultraviolet (UV) light. Some prior art floating wetlands comprise an ethylene vinyl acetate (EVA) foam, which may be more susceptible to UV degradation. Further, The Dow Chemical Company indicates that EVA is “considered to be slightly to moderately toxic to aquatic organisms . . . [and] highly toxic to fish” (http://www.dow.com/productsafety/finder/vinyl.htm#EnvironmentalInfo).

The buoyant plant habitat of embodiments of the invention may comprise a single large grid structure, or may comprise a plurality of smaller individual grid panels joined together in a rigid assembly. For example, in one embodiment of the invention an individual grid panel is 48 inches wide by 96 inches long by 2 inches tall. A buoyant plant habitat may then comprise a plurality of these 48 by 96 inch individual grid panels in any desired configuration and of nearly any desired size. Additionally, two or more large grid structures (or two or more assemblies of smaller individual grid panels) may be joined together, typically using flexible connectors, to form a much larger buoyant plant habitat. Flexible connectors are used to permit the segments of the buoyant plant habitat to move independently in response to wave action or other water movement.

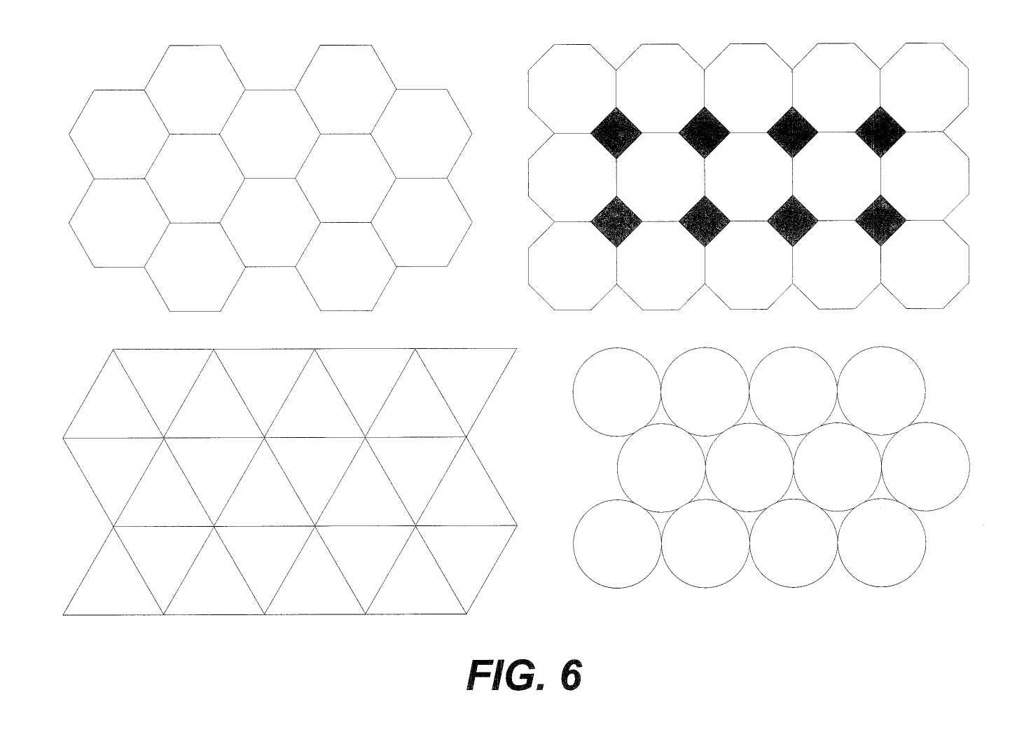

As seen in FIG. 4, the grid comprises a plurality of cells in a single layer horizontally planar arrangement. FIG. 4 illustrates cubic cells (i.e., all six sides being substantially equal in size). However, the cells could have any suitable shape. For example, the cells may be cuboid (typically a rectangular cuboid, which is also termed a right rectangular prism or a rectangular parallelepiped). Many other cell shapes are possible, including mixes of two or more different shapes. FIG. 6 illustrates partial top views of four other possible cell shape configurations: (1) hexagonal, (2) octagonal with square insets (the square insets may be cells which themselves have openings to receive plants, or the square insets may have solid tops and/or bottoms such that no plants are contained in these square insets), (3) triangular, and (4) circular.

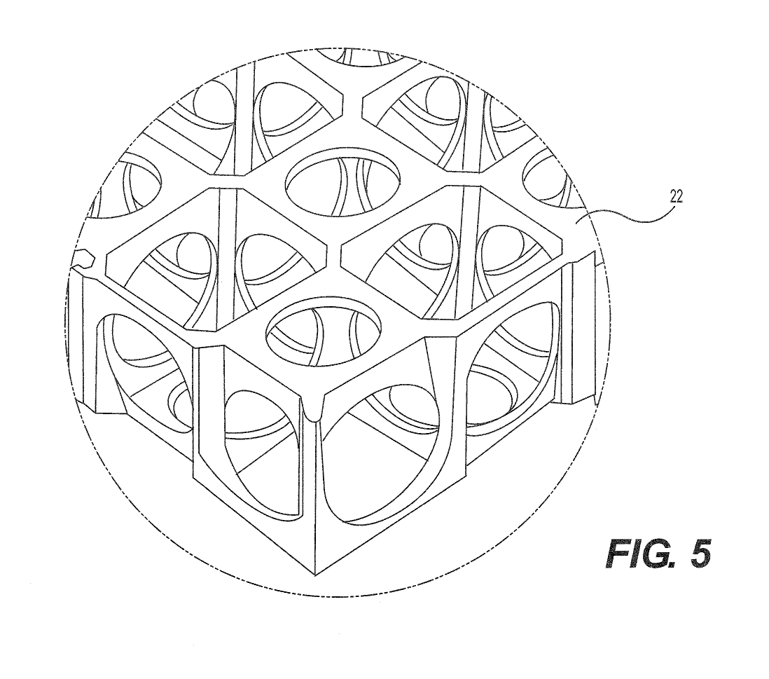

The grid of FIG. 4 comprises a plurality of cubic cells 22, each cell having a top, a bottom, and four vertical sides. Most, if not all, of the cells have openings defined in most, if not all, of its six sides. For example, in FIG. 4, all of the cells have openings defined in the tops and bottoms, and almost all of the cells have openings defined in all four vertical walls (a small number of the cells have one vertical side without an opening). Some of the openings are circular and some are square (the square openings in FIG. 4 span the entire side of the cell, but this may not be the case in all embodiments of the invention). The shape and size of the openings may vary, even within the same embodiment of the invention. FIG. 5 provides an enlarged view of four cells of the rigid grid structure of FIG. 4.

The openings defined in the tops, bottoms, and vertical sides are important for at least two reasons. These openings enable water to easily reach the aquatic plants, and enable flow of the water around and through the aquatic plants. This results in much greater contact between the plants and the water, and thereby much greater uptake of excess nutrients and other pollutants. Additionally, the openings in the tops and bottoms (coupled with the spaced apart placement of plants into the grid, as discussed below) enable sunlight to at least partly penetrate the buoyant plant habitat. This sunlight penetration is important to ensure the health and viability of plants and animals underneath the buoyant plant habitat (allowing sunlight to penetrate is one of the big concerns expressed by ecologists about floating wetlands in the past).

The circular openings defined in the tops of the cells may be sized to accept standard sized plant plugs and bareroot plants (or ‘juvenile plants’ instead of ‘standard sized plant plugs and bareroot plants’, for example standard 1.25 inch plugs and bareroot plants. The aquatic plants may be inserted into some but not all of the cells. For example, it may be desirable to use four plants per square foot of grid structure. However, densities can be increased or decreased if so desired. For example, fewer than 10% of the cells might contain a plant to ensure adequate sunlight penetration. The aquatic plants will grow quickly and fill in void spaces. Referring now to FIG. 6, a cross-sectional view of a buoyant plant habitat is illustrated in accordance with embodiments of the present invention. FIG. 7 illustrates plants placed into every fourth cell, although this spacing may vary. FIG. 7 shows the tops 16a of the plants above the grid structure, and the roots 16b below. As seen in FIG. 7, the roots 16b of the plants also grow within and between the void spaces of the grid structure.

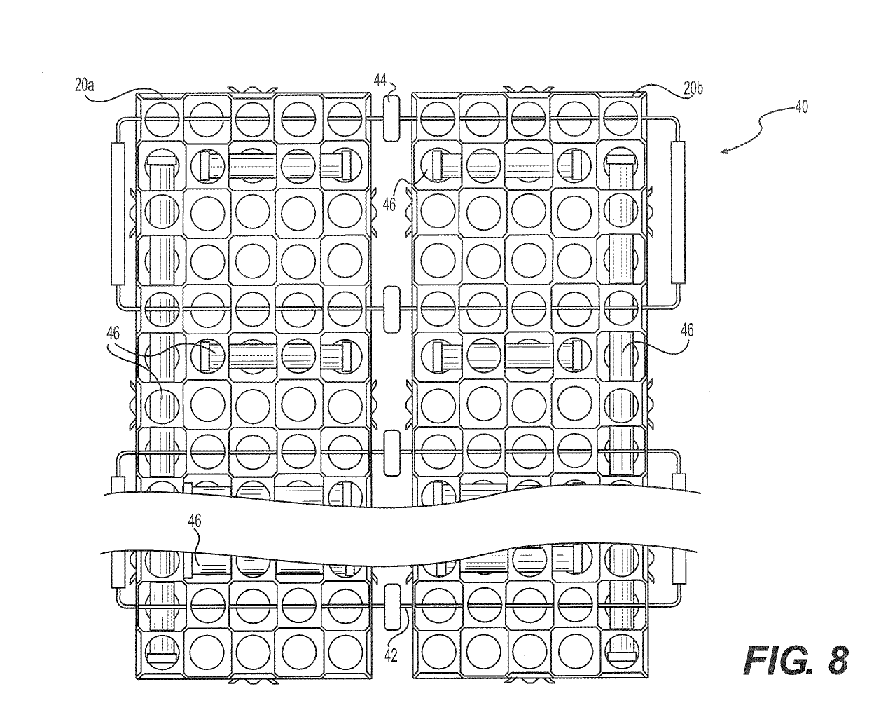

The buoyant plant habitat of embodiments of the invention comprises one or more flotation elements. The flotation element may be integral with the grid structure (e.g., the grid structure is inherently buoyant). Alternatively the floatation element or elements may be coupled to the grid structure to provide the necessary buoyancy. Referring now to FIG. 8, a top view of a multi-grid buoyant plant habitat is illustrated in accordance with embodiments of the present invention. As discussed above, two or more large grid structures (or two or more assemblies of smaller individual grid structures) may be joined together, typically using flexible connectors, to form a much larger multi-part buoyant plant habitat. FIG. 8 illustrates two such grid structures 20a, 20b joined together to form a large multi-part buoyant plant habitat 40. The floatation element for the buoyant plant habitat of the embodiment of FIG. 8 comprises a plurality of capped pipes 46 inserted within the holes of the grid structures, each pipe thereby spanning a plurality of cells. The capped pipes may comprise any suitable material with a high strength to weight ratio, such as PVC. The capped pipes provide a sealed void space which provides buoyancy. FIG. 8 illustrates a truncated grid structure, so only five pipes are illustrated within each grid structure of FIG. 8, with several pipes being arranged in parallel spacing across the structure and pipes along two of the edges that are perpendicular to the several parallel pipes, thereby resulting in a “ladder-type” arrangement. While FIG. 8 illustrates four pipes in a ladder arrangement in each grid structure, any suitable number and any suitable arrangement of floatation elements may be used, as long as sufficient buoyancy is provided to the structure.

The two grid structures 20a, 20b are joined together with a flexible connector element 42. In the embodiment of FIG. 8, the flexible connector element 42 comprises one or more ropes, cables, or the like threaded through the cells of both grid structures and spanning from one grid to the other grid. The sections of rope that span the gap between grid structures are each threaded through a spacer 44. Spacer 44, in conjunction with the flexible nature of the rope, enables the independent movement of the grid structures. Spacer 44 may comprise a rubber washer or “donut.”

The buoyant plant habitat 40 of FIG. 8 further comprises a plurality of handles 48 to facilitate moving the buoyant plant habitat, especially into and out of the body of water. In the embodiment of FIG. 8, the handles 48 comprise lengths of rigid, hollow pipe (e.g., PVC) through which a loop of the rope 42 is threaded.

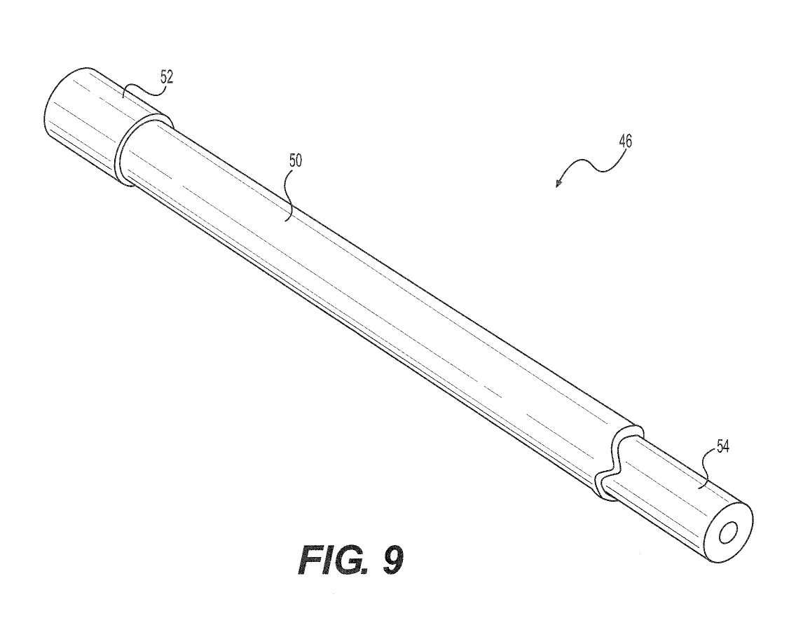

Referring now to FIG. 9, a perspective cut-away view of a flotation element of a buoyant plant habitat is illustrated in accordance with embodiments of the present invention. The floatation element 46 illustrated in FIG. 9 is one of the floatation elements of the buoyant plant habitat of FIG. 8. The floatation element 46 comprises a hollow pipe 50 with a cap 52 at both ends (only one end is illustrated having a cap as the other end is a cutaway view). The caps substantially seal both ends of the pipe to keep water out of the pipe, thereby creating buoyancy. The caps may be affixed to the pipe by any suitable means, including bonding (e.g., gluing or epoxying), threading, or simply via friction with tight dimensional tolerances between the caps and pipe. Optionally, the floatation element 46 may further comprise additional buoyant material 54 within the pipe. For example, this additional buoyant material may comprise an expanded polystyrene “noodle,” however any suitable buoyant material may be used. This additional buoyant material provides a significant amount of additional buoyancy to the floatation element 46, and provides redundant buoyancy in case water penetrates into the pipe.

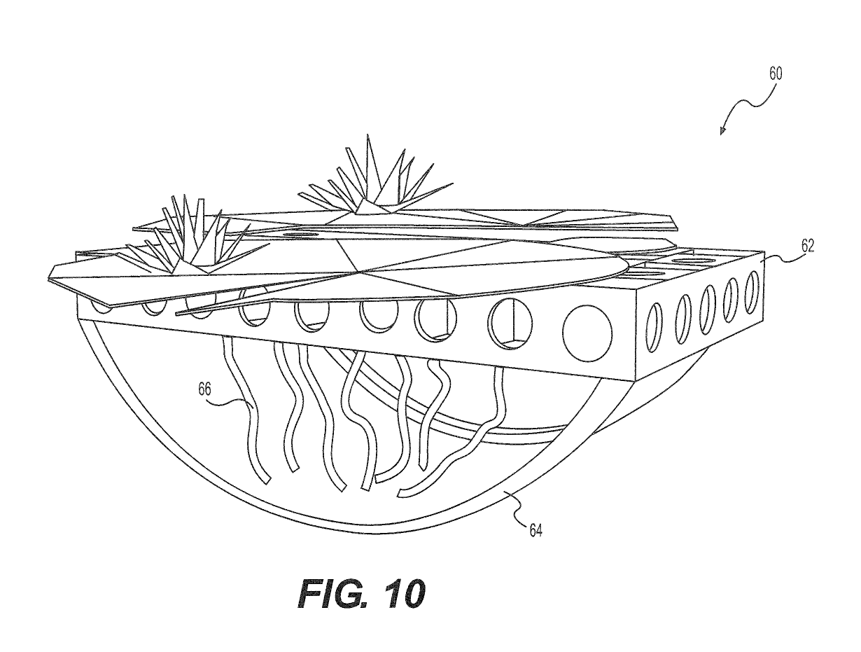

Referring now to FIG. 10, a perspective view of a buoyant plant habitat is illustrated in accordance with an alternative embodiment of the present invention. The buoyant plant habitat 60 of FIG. 10 comprises a sub-structure 64 affixed to and positioned below at least a portion of the grid structure 62. The sub-structure 64 may comprise, for example, a geotextile. As illustrated, opposing ends of the geotextile are affixed to respective opposing ends of the grid structure such that the geotextile hangs down from the grid structure thereby maintaining a gap between a bottom of the grid structure and the geotextile. The geotextile enables the buoyant plant habitat to contain aquatic lily pad plants when positioned in deep water, as such plants require a bottom surface for the roots 66 to contact. Additionally, the geotextile serves as a barrier to prevent the roots of any of the aquatic plants in the buoyant plant habitat from attaching to or rooting in the bottom surface of the body of water and afford protection to the plant roots.

It has been determined that having the buoyant plant habitat of embodiments of the invention cover about 5% of the surface area of the body of water in which it is placed will effectively remove nitrogen and phosphorus and other pollutants to approximately 75-80% or greater removal rates, depending upon the specific nutrient loading of the body of water. For example, to improve a one acre pond's water quality, multiply one acre (43,560 SF) by 0.05, to arrive at a recommended coverage of 2178 square feet of buoyant plant habitat. In one embodiment of the invention, each panel of the grid structure is 32 square feet in size. Thus in this example, 68 panels would be recommended.

Use of the buoyant plant habitat of embodiments of the invention may reduce or eliminate the need for a littoral shelf in the body of water. To shrink the size of a stormwater pond with a littoral shelf, first calculate total existing volume including littoral shelf volume—this variable is termed ‘A’. Next, calculate the volume over the littoral shelf (the volume over the shelf will be the volume of the pond's footprint area with a permanent pool depth of less than 3.5 feet (the area where photosynthesis normally occurs)—this variable is termed ‘C’. Now take the pond's non-littoral shelf volume—this variable is termed ‘B’. The calculation to determine how much the pond size may be reduced is as follows (note: each regulatory body may require a different calculation, so the following should only be used as a guideline): total existing volume=A or (B+C); volume of non-littoral area=B; volume of littoral area=C (volume over 3.5 feet depth); average depth of non-littoral volume=D; average depth of littoral volume=E; and square foot (SF) surface area of floating wetlands to replace littoral shelf=F.

As an example, assume a two acre rectangular pond with a width of 415 feet, a length of 210 feet, and an average non shelf depth of 10 feet. The littoral shelf surface area (the SF around the edge with a depth of less than 3.5 feet and averaging 1.6 feet (E)) is 10 feet. B=395 feet×190 feet×10 feet (‘D’ avg. depth)=750,500 cubic feet. C=1210 linear feet (LF)×10×1.6=19,360 cubic feet. Add B+C for total pond volume: B+C=769,860 cubic feet. Using 10 feet average depth (D) and keeping the length at 210 feet, solve for the new width (769,860/10/210=366.60 feet). The old pond surface area was 415 feet by 210 feet, or 87,150 SF. The new pond size is 210 feet by 366.60 feet or 76,986 SF, for a pond size reduction of 10,164 SF (approximately ¼ acre savings). The number of individual 32 SF grid panels of embodiments of the invention needed is 87,150×5%=approximately 136.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A buoyant plant habitat comprising:
a rigid grid structure comprising a plurality of cells in a single layer horizontally planar arrangement, each cell having a top, a bottom, and at least three sides, each cell having openings defined in its top, bottom, and at least two of the at least three sides;
a flotation element coupled to the grid structure; and
a plurality of aquatic plants, at least one of each aquatic plant inserted within one of the cells.

2. The buoyant plant habitat of claim 1, wherein the plurality of cells each comprise a cubic cell having a top, a bottom, and four sides.

3. The buoyant plant habitat of claim 1, wherein the plurality of cells are arranged in a single layer.

4. The buoyant plant habitat of claim 1, further comprising:
two or more rigid grid structures joined by one or more flexible connector elements.

5. The buoyant plant habitat of claim 1, wherein the rigid grid structure comprises a non-biodegradable material.

6. The buoyant plant habitat of claim 5, wherein the non-biodegradable material comprises a polymer.

7. The buoyant plant habitat of claim 1, wherein the flotation element comprises one or more closed pipes inserted through the openings of and thereby spanning a plurality of cells.

8. The buoyant plant habitat of claim 7, wherein the flotation element further comprises buoyant material within one or more of the closed pipes.

9. The buoyant plant habitat of claim 1, further comprising a sub-structure affixed to and positioned below at least a portion of the grid structure such that a gap is maintained between a bottom of the grid structure and the non-permeable sub-structure.

10. The buoyant plant habitat of claim 9, wherein the sub-structure comprises a geotextile.

11. The buoyant plant habitat of claim 10, wherein opposing ends of the geotextile are affixed to respective opposing ends of the grid structure such that the geotextile hangs down from the grid structure.

12. A method of remediating contaminated water, the method comprising:
providing a buoyant plant habitat comprising:
(i) a rigid grid structure comprising a plurality of cells in a single layer horizontally planar arrangement, each cell having a top, a bottom, and at least three sides, each cell having openings defined in its top, bottom, and at least two of the at least three sides;
(ii) a flotation element coupled to the grid structure; and
(iii) a plurality of aquatic plants, at least one of each aquatic plant inserted within one of the cells;
installing the buoyant plant habitat upon at least a portion of a surface area of a reservoir that contains contaminated water; and
occasionally top-cutting the plurality of aquatic plants to remove contaminants absorbed/sequestered by the plants.

13. The method of claim 12, wherein the plurality of cells each comprise a cubic cell having a top, a bottom, and four sides.

14. The method of claim 12, wherein the plurality of cells are arranged in a single layer.

15. The method of claim 12, wherein the buoyant plant habitat further comprises two or more rigid grid structures joined by one or more flexible connector elements.

16. The method of claim 12, wherein the rigid grid structure comprises a non-biodegradable material.

17. The method of claim 16, wherein the non-biodegradable material comprises a polymer.

18. The method of claim 12, wherein the flotation element comprises one or more closed pipes inserted through the openings of and thereby spanning a plurality of cells.

19. The method of claim 18, wherein the flotation element further comprises buoyant material within one or more of the closed pipes.

20. The method of claim 12, wherein the buoyant plant habitat further comprises a sub-structure affixed to and positioned below at least a portion of the grid structure such that a gap is maintained between a bottom of the grid structure and the sub-structure.

21. The method of claim 20, wherein the sub-structure comprises a geotextile.

22. The method of claim 21, wherein opposing ends of the geotextile are affixed to respective opposing ends of the grid structure such that the geotextile hangs down from the grid structure.
